(19) United States
(12) Patent Application Publication
(10) Pub. No.: US 2023/0183103 A1
(43) Pub. Date: Jun. 15, 2023

(54) ELECTRODE REGENERATION IN ELECTROCHEMICAL DEVICES

(71) Applicant: PowerTech Water, Inc., Lexington, KY (US)

(72) Inventors: Alan Rassoolkhani, Lexington, KY (US); James Landon, Lexington, KY (US); Bradley Nightengale, Lexington, KY (US); Elliott Rushing, Lexington, KY (US); Cassie Roberts, Lexington, KY (US); Cameron Lippert, Lexington, KY (US)

(21) Appl. No.: 18/078,373

(22) Filed: Dec. 9, 2022

Related U.S. Application Data
(60) Provisional application No. 63/287,694, filed on Dec. 9, 2021.
(60) Provisional application No. 63/375,710, filed on Sep. 15, 2022.

(51) Int. Cl. C02F 1/461; C09K 13/04

(52) U.S. Cl. CPC C02F 1/46109; C09K 13/04; C02F 2001/46133; C02F 2001/46119; C02F 2101/20

(57) ABSTRACT

A method for removing a metal from a carbonaceous electrode includes providing a regeneration solution that includes an acid, an oxidizing agent, or a combination thereof. The method further includes applying the regeneration solution to the carbonaceous electrode, and oxidizing the metal on the surface of the carbonaceous electrode. The method also includes collecting the oxidized metal in the regeneration solution.

### CROSS-REFERENCE TO RELATED APPLICATIONS

This application claims benefit of U.S. Provisional Patent Application Ser. No. 63/287,694, filed Dec. 9, 2021, and U.S. Provisional Patent Application Ser. No. 63/375,710, filed Sep. 15, 2022, both of which are incorporated herein in their entirety.

### FEDERAL FUNDING

This invention was made with government support under DE-SC0021567 from the United States Department of Energy. The government has certain rights in the invention.

### BACKGROUND

The present disclosure relates to electrochemical devices, and more particularly, to electrode regeneration in electrochemical devices.

Various methods are used to remove heavy metals and other target species from wastewater and process water. Such methods include, for example, chemical precipitation, ion exchange, adsorption, membrane filtration, reverse osmosis, and electrochemical treatment. Electrochemical cells for removing heavy metals include one or more pairs of electrodes, an anode and a cathode, that remove or reduce the concentration of target species from an input stream and thereby provide an output stream with decreased content of the target species. In particular, when a sufficient external voltage (i.e., potential) is applied to the electrodes, non-spontaneous chemical reactions occur that reduce the concentration of target species (e.g., metal ions, halide ions, derivatives of target metals or target halides, or particulate metals) in the aqueous solution. Depending on the process conditions, e.g., applied voltage, pH, type and concentration of target species, electrode spacing, and cell design, target species are selectively removed from the aqueous solution by various processes, including physical adsorption to an electrode; electrical attraction (i.e., capacitive adsorption) to an electrode; and/or electron transfer reactions that directly or indirectly create new target species (i.e., Faradaic reactions) that become immobilized on an electrode.

### BRIEF DESCRIPTION

According to one or more embodiments, a method for removing a metal from a carbonaceous electrode includes providing a regeneration solution that includes an acid, an oxidizing agent, or a combination thereof. The method further includes applying the regeneration solution to the carbonaceous electrode, and oxidizing the metal on the surface of the carbonaceous electrode. The method further includes collecting the oxidized metal in the regeneration solution.

According to other embodiments, a regeneration solution for a carbonaceous electrode includes an acid and an oxidizing agent in an amount of about 0.1 to about 5 volume percent, or about 0.1 to about 5 weight percent. The regeneration solution has a pH of about 0.5 to about 10.

### BRIEF DESCRIPTION OF THE SEVERAL VIEWS OF THE DRAWINGS

For a more complete understanding of this disclosure, reference is now made to the following brief description, taken in connection with the accompanying drawings and detailed description, wherein like reference numerals represent like parts:

FIG. 1 is a flow chart illustrating a method of regenerating a carbon-based electrode;

FIG. 2A is a cross-sectional side view of a stacked electrochemical device;

FIG. 2B is a cross-sectional side view of a stacked electrochemical device with a membrane on the anode;

FIG. 2C is a cross-sectional side view of a stacked electrochemical device with a membrane on the cathode;

FIG. 2D is a cross-sectional side view of a stacked electrochemical device with a membrane on the anode and a membrane on the cathode;

FIG. 3 is a Pourbaix diagram for copper (Cu); and

FIG. 4 is a system for regenerating a carbon-based electrode.

### DETAILED DESCRIPTION

Electrochemical devices with carbon-based electrodes provide a highly efficient and environmentally friendly process to remove and reduce the content of target species (e.g., heavy metals and other targets) from wastewater. By using the Pourbaix diagram (or potential/pH diagram) of the target species, which illustrates possible stable (equilibrium) phases of a target species in an aqueous electrochemical system, the desired applied potential (E) can be selected to selectively remove the target species on the anode or cathode. Upon application of the appropriate voltage, electrochemical devices with one or more carbon-based electrodes can remove target species by electroplating (i.e., plating or electrodepositing) on the carbon-based cathode. Over time, the target species is removed to levels down to single digit parts per billion (ppb) in the output stream after treatment. However, a challenge of such efficient processes is that high levels of reduced metals accumulate on the surface of the carbon-based electrodes, ultimately requiring the electrodes to be replaced. Repeated electrode cartridge replacement is costly.

Accordingly, described herein is a regeneration solution, system, and method that oxidizes accumulated reduced metal on a surface of the carbon-based (i.e., carbonaceous) cathode. The regeneration solution includes one or more strong acids and an oxidizing agent, such as a peroxide. The regeneration solution is applied to the carbon-based electrode under conditions that recover the oxidized previously accumulated metal on the electrode to regenerate the electrode with an efficiency of greater than 50% in some embodiments. The regeneration solution, device, system, and method thus provide a simple and efficient method of both recovering metals from aqueous solutions (e.g., wastewater streams) and reducing the frequency that carbon-based electrodes require replacement, providing a significant decrease in the cost of the electrodes and the electrochemical device and system.

### Regeneration Method

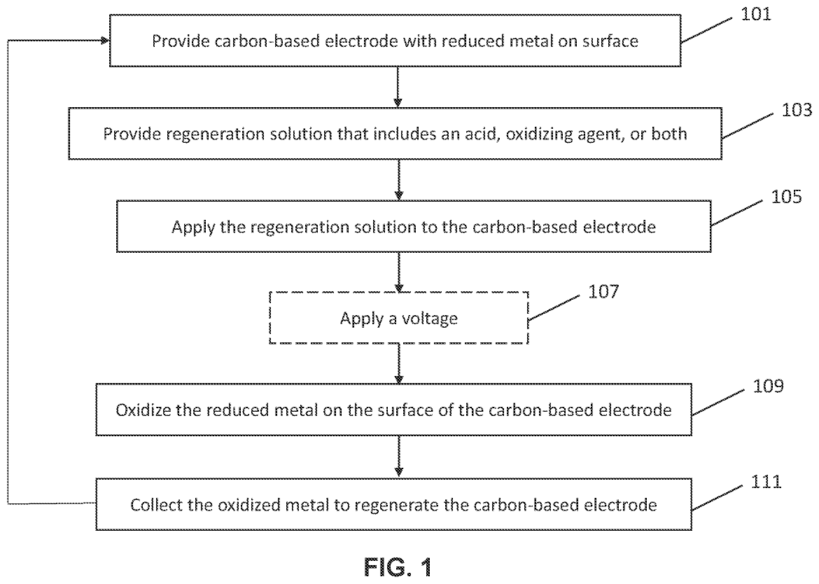

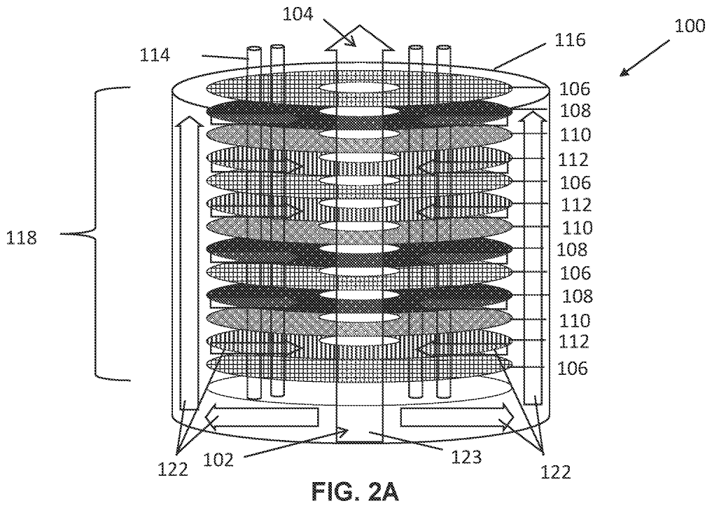

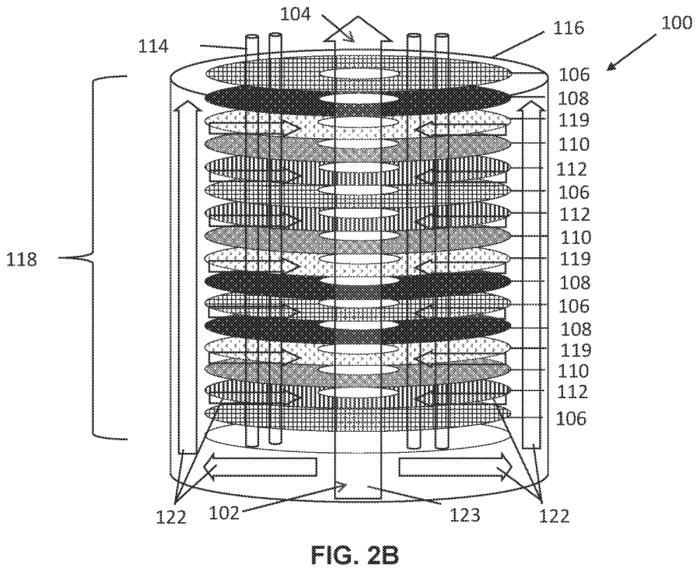

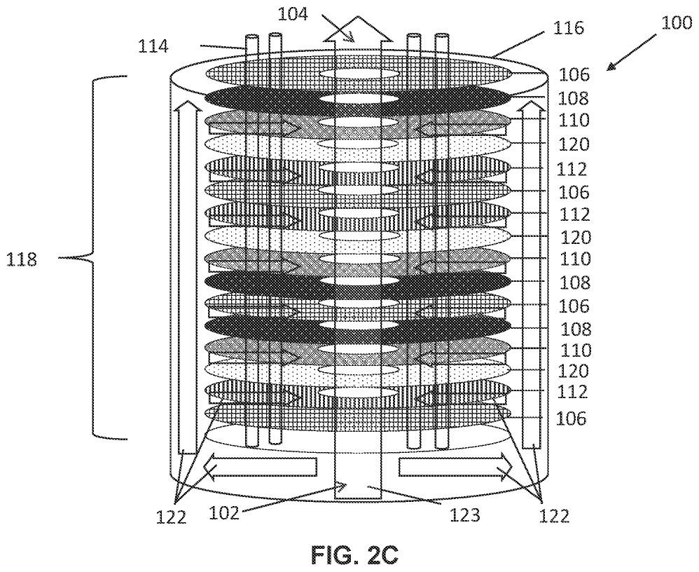

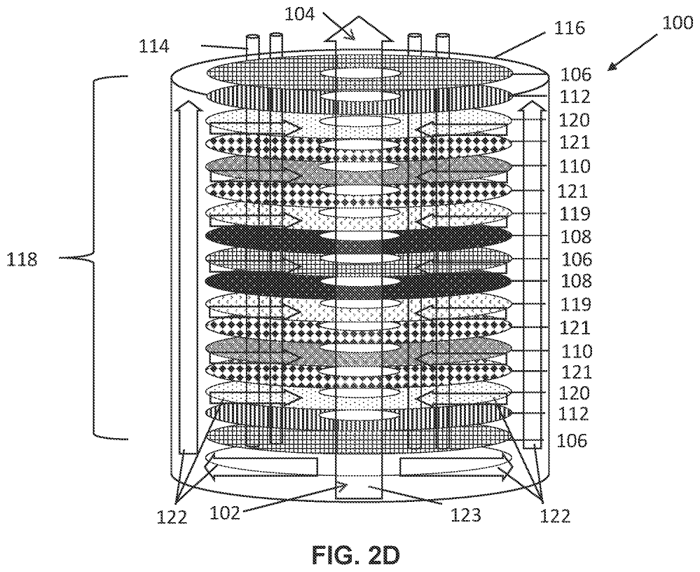

FIG. 1 is a flow chart illustrating a method of regenerating a carbon-based electrode. The method includes, as shown in box 101, providing a carbon-based electrode with reduced metal on surface. In some embodiments, the carbon-based electrode is the carbon-based cathode 112 described and shown in FIGS. 2A-2D. The carbon-based electrode is a single electrode in embodiments (e.g., a carbon-based anode or a carbon-based cathode), or part of an electrode stack with another electrode, such as another carbon-based electrode or another non-carbon-based electrode (e.g., a metal-based (i.e., metal-containing) electrode 108 as described in FIGS. 2A-2D below). In some embodiments, the carbon-based electrode is a carbon felt, a woven carbon cloth, or a carbon film, all of which are described in further detail below. In some embodiments, carbon-based electrode includes a composite of carbon black, activated carbon, carbon nanotubes, graphene sheets, or any combination thereof, and a polymer binder such as polyvinylidene fluoride (PVDF), polytetrafluoroethylene (PTFE), or any combination thereof.

In some embodiments, the electrode stack further includes a membrane on the carbon-based electrode and/or on the another carbon-based electrode or another non-carbon-based electrode (e.g., a metal-based electrode). The membrane may be a cation exchange membrane 120 or an anion exchange membrane 119 depending on which electrode the membrane is arranged on. A cation exchange membrane is a membrane that is selectively permeable to cations. An anion exchange membrane is a membrane that is selectively permeable to anions. The membrane is a bipolar membrane in some embodiments. The membrane is in a form of a film, a layer, a sheet, a coating, or a combination thereof, and the membrane is arranged on a surface of an electrode or is free-standing. In some embodiments, the membrane is a porous sheet or a mesh sheet. The membrane is on, directly on, or in contact with the electrode in some embodiments. In other embodiments, the membrane surrounds the electrode.

The reduced metal on the surface of the carbon-based electrode is in some embodiments a target species from an aqueous solution from an industrial wastewater stream or a residential water stream. Non-limiting examples of the reduced metals include silver (Ag), copper (Cu), chromium (Cr), lead (Pb), cadmium (Cd), nickel (Ni), zinc (Zn), or any combination thereof. In some embodiments, the chromium is Cr (VI), which is reduced to Cr (III) on the carbon-based electrode.

In some embodiments, the reduced metal on the surface of the carbon-based electrode is accumulated from being electroplated upon application of an appropriate voltage to the carbon-based cathode. The voltage in some embodiments, is a negative voltage. In one or more embodiments, the carbon-based electrode includes accumulated and electroplated metal from an aqueous solution.

The method includes, as shown in box 103, providing a regeneration solution that includes an acid and an oxidizing agent. In some embodiments, the oxidizing agent is a peroxide, a persulfate, or a combination thereof. Non-limiting examples of the oxidizing agent include hydrogen peroxide, sodium persulfate, potassium persulfate, sodium hypochlorite, chlorine, or any combination thereof. In some embodiments, the acid in the regeneration solution is sulfuric acid. In embodiments, the peroxide is hydrogen peroxide. In some embodiments, the regeneration solution includes an acid. In other embodiments, the regeneration solution includes an oxidizing agent. In some embodiments, the regeneration solution with the oxidizing agent is applied to the carbon-based electrode, and subsequently, the acid is applied to the carbon-based electrode.

The method includes, as shown in box 105, applying the regeneration solution to the carbon-based electrode. The regeneration solution is applied to soak or saturate the carbon-based electrode. In some embodiments, the regeneration solution is flushed through the system by backflushing or reversing the flow direction relative to the flow used to remove the metal from the aqueous solution. In embodiments, the temperature used during regeneration is about 5 degrees Celsius to about 50 degrees Celsius. In some embodiments, the temperature used during regeneration is about 15 degrees Celsius to about 25 degrees Celsius. Yet, in other embodiments, the temperature used during regeneration is about or in any range between about 5, 7, 10, 12, 15, 17, 20, 22, 25, 27, 30, 32, 35, 37, 40, 42, 45, 47, and 50 degrees Celsius.

In some embodiments, the flow rate for the regeneration solution used during regeneration is about 0.5 to about 5 gallons per minute. In some embodiments, the flow rate is about 1 to about 4 gallons per minute. Yet, in other embodiments, the flow rate during regeneration is about or in any range between about 0.5, 1, 1.5, 2, 2.5, 3, 3.5, 4, 3.5, and 5 gallons per minute. In one or more embodiments, the flow rate for regeneration is about 1 to about 1.8 gallons per minute.

In some embodiments, the system pressure maintained during regeneration is about 1 to about 60 pounds force per square inch (psi). In some embodiments, the system pressure is about 5 to about 30 pounds force per square inch. Yet, in other embodiments, the system pressure during regeneration is about or in any range between about 1, 5, 10, 15, 20, 25, 30, 35, 40, 45, 50, 55, and 60 pounds force per square inch.

The time required for regeneration depends on a variety of conditions. In embodiments, regeneration under the above conditions is performed for about 0.25 to about 8 hours. In some embodiments, regeneration under the above conditions is performed for about 0.5 to about 4 hours. Yet, in other embodiments, regeneration under the above conditions is performed for about 0.25, 0.50, 1, 1.5, 2, 2.5, 3, 3.5, 4, 4.5, 5, 5.5, 6, 6.5, 7, 7.5, and 8 hours.

The method includes, as shown in box 107, optionally, applying a voltage while flushing the carbon-based electrode. In one or more embodiments, a voltage is not applied during regeneration. In some embodiments, an open circuit is applied. In other embodiments, a short circuit voltage is applied.

The method includes, as shown in box 109, oxidizing the reduced metal on the surface of the carbon-based electrode. During regeneration described above, the reduced accumulated metal on the carbon-based electrode will oxidize and form a charged ionic species in the bulk solution (i.e., the regeneration solution). For example, Cu(s) plated on the electrode surface will become Cu²⁺.

The method includes, as shown in box 111, collecting the oxidized metal to regenerate the carbon-based electrode. Once the accumulated metal has been sufficiently oxidized and removed from the electrode surface, the oxidized metal in the aqueous solution (i.e., the regeneration solution) is collected. The above regeneration conditions are varied to provide any desired endpoint, which can be measured by the amount of metal ions released from the electrode surface and into the regeneration solution. In one or more embodiments, regeneration is performed until the metal is present in the regeneration solution in an amount of about 50,000 to about 100,000 parts per million. In other embodiments, regeneration is performed until the metal is present in the regeneration solution in an amount of about 1,000 to about 100,000 parts per million. Still yet, regeneration is performed until the metal is present in the regeneration solution in an amount about or in any range between about 1,000; 5,000; 10,000; 15,000; 20,000; 25,000; 30,000; 35,000; 40,000; 45,000, 50,000; 55,000; 60,000; 65,000; 70,000; 75,000; 80,000; 85,000; 90,000; and 100,000 parts per million.

The carbon-based electrode can then be used again to collect reduced metal and regenerated any number of times. The carbon-based electrode or electrode stack with the carbon-based electrode will need to be replaced when it can no longer draw enough current to reduce a metal on its surface.

### Regeneration Solution

The regeneration solution includes an acid, an oxidizing agent, or a combination thereof. The acid is one or more acids. In some embodiments, the acid includes one or more strong acids. In embodiments, the regeneration solution includes a first acid and a second acid. In other embodiments, the first acid is a first strong acid, and the second acid is a second strong acid. Non-limiting examples of strong acids include sulfuric acid (H₂SO₄), hydrochloric acid (HCl), nitric acid (HNO₃), hydrobromic acid (HBr), hydroiodic acid (HI), perchloric acid (HClO₄), and chloric acid (HClO₃). At least one of the acids, when more than one is used in the regeneration solution, is used to adjust the pH of the regeneration solution to an acidic pH. In one or more embodiments, the pH of the regeneration solution is adjusted to 6 or less. In some embodiments, the pH of the regeneration solution is adjusted to 2 or less. In other embodiments, the pH of the regeneration solution is adjusted to 10 or less. In other embodiments, the pH of the regeneration solution is adjusted to about, less than, or between about 0.5, 1, 1.5, 2, 2.5, 3, 3.5, 4, 4.5, 5, 5.5, 6, 6.5, 7, 7.5, 8, 8.5, 9, 9.5, or 10.

In some embodiments, the oxidizing agent in the regeneration solution is in an amount of about 0.1 to about 1 volume %. In embodiments, the oxidizing agent in the regeneration solution is in an amount of about 0.1 to about 5 volume %. In other embodiments, the oxidizing agent in the regeneration solution is in an amount of about 0.3 to about 0.6 volume %. Yet, in other embodiments, the oxidizing agent in the regeneration solution is in an amount about or any range between about 0.1, 0.2, 0.3, 0.4, 0.5, 0.6, 0.7, 0.8, 0.9, 1.0, 1.1, 1.2, 1.3, 1.4, 1.5, 1.5, 1.6, 1.7, 1.8, 1.9, 2.0. 2.1, 2.2, 2.3, 2.4, 2.5, 2.6, 2.7, 2.8, 2.9, 3.0, 3.1, 3.2, 3.3, 3.4, 3.5, 3.6, 3.7, 3.8, 3.9, 4.0, 4.1, 4.2, 4.3, 4.4, 4.5, 4.6, 4.7, 4.8, 4.9 and 5.0 volume %. In embodiments, the oxidizing agent in the regeneration solution is in an amount of about 0.1 to about 1 weight %. In embodiments, the oxidizing agent in the regeneration solution is in an amount of about 0.1 to about 5 weight %. In other embodiments, the oxidizing agent in the regeneration solution is in an amount of about 0.3 to about 0.6 weight %. Yet, in other embodiments, the oxidizing agent in the regeneration solution is in an amount about or any range between about 0.1, 0.2, 0.3, 0.4, 0.5, 0.6, 0.7, 0.8, 0.9, 1.0, 1.1, 1.2, 1.3, 1.4, 1.5, 1.5, 1.6, 1.7, 1.8, 1.9, 2.0. 2.1, 2.2, 2.3, 2.4, 2.5, 2.6, 2.7, 2.8, 2.9, 3.0, 3.1, 3.2, 3.3, 3.4, 3.5, 3.6, 3.7, 3.8, 3.9, 4.0, 4.1, 4.2, 4.3, 4.4, 4.5, 4.6, 4.7, 4.8, 4.9 and 5.0 weight %.

In some embodiments, the regeneration solution includes a chelating agent. Non-limiting examples of chelating agents include ethylenediamine tetraacetic acid (EDTA), glycine, polyethylene glycol (PEG), Polyethylenimine (PEI), bis(3-sulfopropyl) disulfide (SPS), ethanolamine, L-alanine, or any combination thereof.

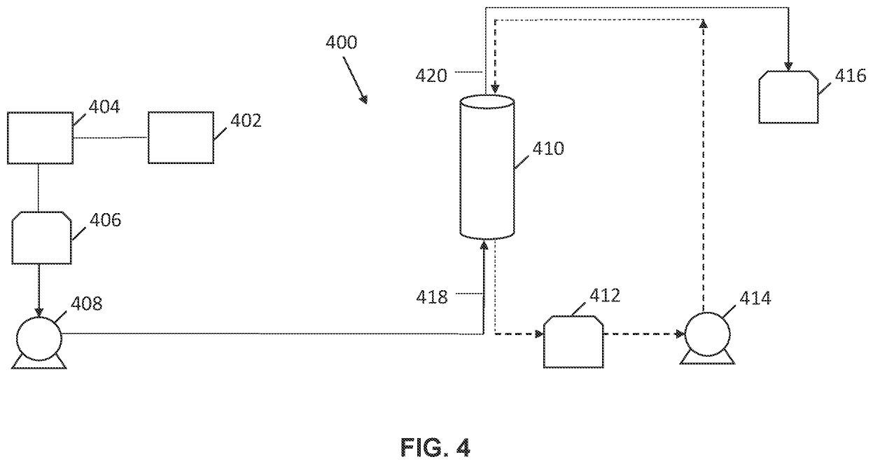

FIG. 4 is a system 400 for regenerating a carbon-based electrode. The system 400 includes an electrode cartridge 410 with the carbon-based electrode. The electrode cartridge 410 is the electrode stack 118 described below in FIGS. 2A-2D in some embodiments. In other embodiments, the electrode cartridge 410 is a carbon-based electrode described below. In some embodiments, the electrode cartridge 410 is a carbon-based cathode paired with a carbon-based anode. The carbon-based electrode in the electrode cartridge 410 includes accumulated reduced metal collected from an aqueous solution 406 that was pumped through the electrode cartridge 410 via a pump 408, power supply 402, and controller 404 within the system 400. When a voltage is applied to the input stream 418, metal is reduced on the carbon-based cathode in the electrode cartridge 410, and the content of the oxidized target species is reduced in the output stream 420, which is collected in the output collector 416. To regenerate the carbon-based electrode of the electrode cartridge 410, the regeneration solution in regeneration tank 412 is periodically back-flushed, using a pump 414, through the carbon-based electrode in the electrode cartridge 410. The reduced metal on the surface of the carbon-based electrode is oxidized and collected in the regeneration solution in the regeneration tank. Over time, the metal species is concentrated in regeneration tank 412 to provide a concentrated oxidized metal in the regeneration solution. The concentrated metal solution in the regeneration tank 412, where there is a higher concentration of metal species than in the aqueous solution 406, can undergo further reduction via plating as described above (electrowinning) to produce a solid metal product.

Electrochemical Device with Carbon-Based Electrode

The carbon-based electrode that is regenerated as described herein may be part of an electrochemical device described in FIGS. 2A-2D in some embodiments. However, the carbon-based electrode is not limited to such devices. In FIGS. 2A-2D, electrochemical device 100 treats an input stream 102 of an aqueous solution (e.g., water) with one or more target species. The input stream 102 enters through an inlet in the housing 116 and is treated to at least partially remove or reduce the content of the one or more target species in the aqueous solution of the input stream 102, providing a treated output stream 104 that exits the housing 116 through an outlet. The output stream 104 includes a reduced content of the target species than the input stream 102 and is then further processed as desired.

The electrochemical device 100 includes one or more electrode stacks 118 of a carbon-based cathode 112 and a metal-based anode 108 arranged in the housing 116. Although one electrode stack 118 is shown, the electrochemical device 100 are not limited to one stack and in other embodiments includes one or more stacks 118, i.e., a plurality of electrode stacks 118 of the carbon-based cathode 112 and the metal-based anode 108. In embodiments, the electrochemical device 100 further includes electrical contacts 114 (or electrical connections) and associated wiring (not shown) between the electrodes. The electrical contacts 114 and associated wiring provide the necessary electrical connections to the electrical power supply (not shown). The carbon-based cathode 112 and the metal-based anode 108 are porous materials that allow for aqueous fluid flow therethrough in some embodiments. In other embodiments, the metal-based anode 108 is non-porous. In some embodiments, as shown in FIGS. 2B and 2D, a membrane 119 (i.e., an anion exchange membrane) is arranged on the metal-based anode 108. In other embodiments, a membrane 120 (i.e., a cation-exchange membrane) is arranged on the carbon-based cathode 112. In embodiments, the membrane 119 and/or membrane 120 is a bipolar membrane. The electrochemical device 100 illustrates a flow-by and a flow-through configuration. However, in embodiments, the electrochemical device operates via a flow-by or a flow-through configuration. In the flow-by configuration, the input stream 102 flows across (indicated by arrows 122) the surfaces of the electrodes rather than through the electrodes. In the flow-through configuration, the input stream 102 flows through (indicated by arrows 123) the electrodes. The flow-by design provides advantages of lower pressure drop, higher flow rate, equal degradation of carbon electrodes, equivalent pH regions generated for each electrode pair. The flow-through design provides more extreme pH regions and improved control over the outlet pH. In stacked electrochemical devices as shown in FIGS. 2A-2D, in which the “stacked” electrodes are arranged in a parallel orientation with planar surfaces that are substantially parallel to one another, the input stream 102 flows-through the electrodes, flows-by the electrodes, or a combination thereof.

In some embodiments, the electrode stack 118 includes one or more optional current collectors 106 attached to or in contact with one or both of the carbon-based cathode 112 and the metal-based anode 108. The current collectors 106 are, for example, sandwiched between layers of the carbon-based cathode 112, and between layers of the metal-based anode 108. The current collectors 106 are electric bridging components that collect electrical current generated at the attached electrode and reduce electrical losses within the electrochemical device 100. In one or more embodiments, the electrode stack 118 is compressed, and the current collectors 106 contact the electrodes. In some embodiments, the electrode is a film or a sheet that is cast onto current collector. The current collector 106 attached to or in contact with the carbon-based cathode 112 and metal-based anode 108 are the same or different. The current collectors 106 are solid or porous materials. The current collectors 106 are films, layers, metal sheets, foil sheets, or mesh sheets. Non-limiting examples of materials for the current collectors 106 for the carbon-based cathode 112 include graphite, titanium, stainless steel, aluminum, copper, nickel, or a combination thereof. Non-limiting examples of materials of current collectors 106 for the metal-based anode 108 include graphite, titanium, stainless steel, aluminum, copper, nickel, or a combination thereof. In one or more embodiments, a current collector 106 is attached to or in contact with the carbon-based cathode 112, and a current collector 106 is not attached to or in contact with the metal-based anode 107.

In some embodiments, the current collector 106 attached to either electrode is a planar structure with a thickness of about 0.1 to about 500 millimeters. In some embodiments, the current collector 106 has a thickness of about 0.1 to about 0.4 millimeters. In other embodiments, the current collector 106 has a thickness about or in any range between about 0.01, 0.05, 0.1, 0.15, 0.20, 0.25, 0.30, 0.35, 0.40, 0.45, 0.50, 0.55, 0.60, 0.65, 0.70, 0.75, 0.80, 0.85, 0.90, 1, 5, 10, 15, 20, 25, 30, 35, 40, 45, 50, 55, 60, 65, 70, 75, 80, 85, 90, 95, 100, 105, 110, 115, 120, 125, 130, 135, 140, 145, 150, 155, 160, 165, 170, 175, 180, 185, 190, 195, 200, 205, 210, 215, 220, 225, 230, 235, 240, 245, 250, 255, 260, 265, 270, 275, 280, 285, 290, 295, 300, 305, 310, 315, 320, 325, 330, 335, 340, 345, 350, 355, 360, 365, 370, 375, 380, 385, 390, 395, 400, 405, 410, 415, 420, 425, 430, 435, 440, 445, 450, 455, 460, 465, 470, 475, 480, 485, 490, 495, and 500 millimeters.

In some embodiments, each current collector 106 is a continuous planar structure without an annular hole therethrough (not shown). In other embodiments, each current collector 106 is a planar structure with an annular hole therethrough, as shown in FIG. 1 for example. In embodiments, the current collector 106 has a thin planar cylindrical shape, with or without an annular hole therethrough. However, the shape of the current collector 106 is not limited to these shapes and can be any shape with the above-described thickness.

In some embodiments as shown in FIGS. 2A-2D, the current collectors 106 are solid (non-porous), and each of the carbon-based cathode 112 and metal-based anode 108 is porous, which allows for both flow-by (arrows 122) and flow-through (arrows 123) flow path configurations. In other embodiments, the current collectors 106, carbon-based cathode 112, and metal-based anode 108 are all porous materials, allowing flow-through (arrows 123) of the electrode stack 118 of the electrochemical device 200.

In one or more embodiments, the electrode stacks 118 further include a separator 110 arranged between the carbon-based cathode 112 and the metal-based anode 108. The separator 110 is a dielectric material and prevents physical contact between the electrodes. Non-limiting examples of dielectric materials for the separator 108 include polymeric materials, cellulosic-based materials, silica-based materials, or any combination thereof. In some embodiments, the separator 110 includes polyethylene.

In some embodiments, the separator 110 is a planar structure with a thickness of about 1 to about 5000 micrometers. In some embodiments, the separator 110 has a thickness of about 50 to about 250 micrometers. In other embodiments, the separator 110 has a thickness about, less than or in any range between about 1, 25, 50, 75, 100, 125, 150, 175, 200, 225, 250, 275, 300, 325, 350, 375, 400, 425, 450, 475, 500, 525, 550, 575, 600, 625, 650, 675, 700, 725, 750, 775, 800, 825, 850, 875, 900, 925, 950, 975, 1000, 1025, 1050, 1075, 1100, 1125, 1150, 1175, 1200, 1225, 1250, 1275, 1300, 1325, 1350, 1375, 1400, 1425, 1450, 1475, 1500, 1525, 1550, 1575, 1600, 1625, 1650, 1675, 1700, 1725, 1750, 1775, 1800, 1825, 1850, 1875, 1900, 1925, 1950, 1975, 2000, 2025, 2050, 2075, 2100, 2125, 2150, 2175, 2200, 2225, 2250, 2275, 2300, 2325, 2350, 2375, 2400, 2425, 2450, 2475, 2500, 2525, 2550, 2575, 2600, 2625, 2650, 2675, 2700, 2725, 2750, 2775, 2800, 2825, 2850, 2875, 2900, 2925, 2950, 2975, 3000, 3025, 3050, 3075, 3100, 3125, 3150, 3175, 3200, 3225, 3250, 3275, 3300, 3325, 3350, 3375, 3400, 3425, 3450, 3475, 3500, 3525, 3550, 3575, 3600, 3625, 3650, 3675, 3700, 3725, 3750, 3775, 3800, 3825, 3850, 3875, 3900, 3925, 3950, 3975, 4000, 4025, 4050, 4075, 4100, 4125, 4150, 4175, 4200, 4225, 4250, 4275, 4300, 4325, 4350, 4375, 4400, 4425, 4450, 4475, 4500, 4525, 4550, 4575, 4600, 4625, 4650, 4675, 4700, 4725, 4750, 4775, 4800, 4825, 4850, 4875, 4900, 4925, 4950, 4975, and 5000 micrometers.

The thickness of the separator 110 that separates the carbon-based cathode 112 from the metal-based anode 108 defines the separation distance between the electrodes. The separation distance between the stacked, or parallel arranged, carbon-based cathode 112 and metal-based anode 108, is critical. The electrodes must be close enough to support viable separation. If the electrodes are too far apparat, separation is not viable. Removal rate is directly proportional to the separator distance with larger distances leading to greater resistance. With separator distances greater than 1000 microns, the removal rate continues to drop precipitously, increasing the voltage required for operation and the likelihood for water splitting to occur, hurting the efficiency of the process. At distances of less than 1 micron, while the reaction rate may be high, the possibility for short circuiting of the cell due to metal deposits connecting between the anode and the cathode, often referred to as dendrites, becomes quite high. Therefore, for practical operation where both high removal rates can be achieved along with reliable operation, a distance of 1-5000 microns is critical. Thus, the separation distance between the carbon-based cathode 112 and the metal-based anode 108 is about 1 to about 1000 micrometers, as described above, in some embodiments. In other embodiments, the separation distance between the carbon-based cathode 112 and the metal-based anode 108 is about or in any range between about 1, 25, 50, 75, 100, 125, 150, 175, 200, 225, 250, 275, 300, 325, 350, 375, 400, 425, 450, 475, 500, 525, 550, 575, 600, 625, 650, 675, 700, 725, 750, 775, 800, 825, 850, 875, 900, 925, 950, 975, 1000, 1025, 1050, 1075, 1100, 1125, 1150, 1175, 1200, 1225, 1250, 1275, 1300, 1325, 1350, 1375, 1400, 1425, 1450, 1475, 1500, 1525, 1550, 1575, 1600, 1625, 1650, 1675, 1700, 1725, 1750, 1775, 1800, 1825, 1850, 1875, 1900, 1925, 1950, 1975, 2000, 2025, 2050, 2075, 2100, 2125, 2150, 2175, 2200, 2225, 2250, 2275, 2300, 2325, 2350, 2375, 2400, 2425, 2450, 2475, 2500, 2525, 2550, 2575, 2600, 2625, 2650, 2675, 2700, 2725, 2750, 2775, 2800, 2825, 2850, 2875, 2900, 2925, 2950, 2975, 3000, 3025, 3050, 3075, 3100, 3125, 3150, 3175, 3200, 3225, 3250, 3275, 3300, 3325, 3350, 3375, 3400, 3425, 3450, 3475, 3500, 3525, 3550, 3575, 3600, 3625, 3650, 3675, 3700, 3725, 3750, 3775, 3800, 3825, 3850, 3875, 3900, 3925, 3950, 3975, 4000, 4025, 4050, 4075, 4100, 4125, 4150, 4175, 4200, 4225, 4250, 4275, 4300, 4325, 4350, 4375, 4400, 4425, 4450, 4475, 4500, 4525, 4550, 4575, 4600, 4625, 4650, 4675, 4700, 4725, 4750, 4775, 4800, 4825, 4850, 4875, 4900, 4925, 4950, 4975, and 5000 micrometers. In some embodiments, each separator 110 is a continuous planar structure without an annular hole therethrough (not shown). In other embodiments, each separator 110 is a planar structure with an annular hole therethrough, as shown in FIGS. 2A-2D for example. In embodiments, the separator 110 has a thin planar cylindrical shape, with or without an annular hole therethrough. However, the shape of the separator 110 is not limited to these shapes and can be any shape with the above-described thickness.

The carbon-based cathode 112 is a carbon-based material. Non-limiting examples of the carbon-based material include carbon cloths, carbon films, activated carbon materials, non-wovens (e.g. carbon felts, carbon aerogels, etc.), or any combination thereof.

Carbon cloths are woven, conductive, porous materials that either consist of or consist essentially of carbon. Woven cloths are textiles formed by weaving. The woven cloths have a high void fraction. Void ratio (or void fraction) describes the open porosity of a carbon material and how easily an aqueous solution can flow through the carbon material. The void ratio (also referred to as void fraction) is a measurement of the amount of aqueous solution (or water) displaced by a piece of carbon material of known dimensions and mass according to the following equation:

$$Void ratio ( \% ) = \frac{{V}_{carbon} - {V}_{water displaced}}{{V}_{carbon}}$$

where V_{carbon} is the volume of the carbon, V_{water} displaced is the volume of water (or aqueous solution) displaced. The units of V_{carbon} and V_{water} displaced are the same, resulting in a void ratio (%). In some embodiments, the woven cloths have a void fraction (also referred to as a void ratio) about 65% to about 99.9%. In other embodiments, the woven cloths have a void fraction of about 70% to about 99.9%. Still yet, in embodiments, the woven cloths have void fractions about or in any range between about 65%, 68%, 70%, 72%, 75%, 78%, 80%, 82%, 85%, 88%, 90%, 92%, 95%, 97%, 99%, and 99.9%.

In some embodiments, the woven cloths have a high surface area of about 700 to about 2300 square meters per gram. In other embodiments, the woven cloths have a high surface area of about 1200 to about 2300 square meters per gram. Yet, in other embodiments, the woven cloths have a high surface area about or in any range between about 700, 750, 800, 850, 900, 950, 1000, 1050, 1100, 1150, 1200, 1250, 1300, 1350, 1400, 1450, 1500, 1550, 1600, 1650, 1700, 1750, 1800, 1850, 1900, 1950, 2000, 2050, 2100, 2150, 2200, 2250, and 2300 square meters per gram. In other embodiments, the woven cloths have a low surface area of about 0.1 to about 5 square meters per gram. Yet, in embodiments, the woven cloths have a low surface area about or in any range between about 0.1, 0.2, 0.3, 0.4, 0.5, 0.6, 0.7, 0.8, 0.9, 1.0, 1.2, 1.4, 1.6, 1.8, 2.0, 2.2, 2.4, 2.6, 2.8, 3.0, 3.2, 3.4, 3.6, 3.8, 4.0, 4.2, 4.4, 4.6, 4.8, and 5.0 square meters per gram.

A non-limiting example of a woven cloth for the carbon-based cathode 112 is a high void fraction (about 65% to about 99.9%) and high surface area (about 700 to about 2300 square meters per gram) material. Another non-limiting example of a woven cloth for the carbon-based cathode is a high void fraction (about 70% to about 99.9%) and high surface area (about 1200 to about 2300 square meters per gram) material, commercially available as KYNOL.

Carbon felts are non-woven porous materials that consist of or consist essentially of carbon. In some embodiments, the carbon felts are activated carbon felts. In other embodiments, the carbon felts are thermally treated or surface oxidized carbon felts. In one or more embodiments, the carbon felt has a void fraction of about or greater than 95%. In other embodiments, the carbon felt has a void fraction of about, greater than, or in any range between about 95%, 96%, 97%, 98%, 99%, and 99.9%, for example about 95% to about 99%, about 95% to about 98%, about 95% to about 97%, and about 95% to about 96%. In one or more embodiments, the carbon felt has a void fraction of about 70% to about 99.9%. In other embodiments, the carbon felt has a void fraction of about or in any range between about 70%, 72%, 75%, 77%, 80%, 82%, 85%, 87%, 90%, 92%, 95%, 97%, 99%, and 99.9%.

In some embodiments, the carbon felt has a low surface area of less than 5 square meters per gram. Still yet, in other embodiments, the carbon felt has a low surface area of about or in any range between about 0.1, 0.2, 0.3, 0.4, 0.5, 0.6, 0.7, 0.8, 0.9, 1.0, 1.2, 1.4, 1.6, 1.8, 2.0, 2.2, 2.4, 2.6, 2.8, 3.0, 3.2, 3.4, 3.6, 3.8, 4.0, 4.2, 4.4, 4.6, 4.8, and 5.0 square meters per gram. In some embodiments, the carbon felt has a high surface area of about 1200 to about 2300 square meters per gram. Still yet, in other embodiments, the carbon felt has a surface area of about or in any range between about 1200, 1250, 1300, 1350, 1400, 1450, 1500, 1550, 1600, 1650, 1700, 1750, 1800, 1850, 1900, 1950, 2000, 2050, 2100, 2150, 2200, 2250, and 2300 square meters per gram.

A non-limiting example of a carbon felt for the carbon-based cathode 112 is a high void fraction (about or greater than 95%) and low surface area (about 0.1 square meters per gram to about 5 square meters per gram) material. Another non-limiting example of an activated carbon felt for the carbon-based cathode 112 is a high void fraction (about 70% to about 99.9%) and high surface area (about 1200 to about 2300 square meters per gram) material.

Carbon films are carbon composites that consists of or consists essentially of carbon particles and a carbon binder. In one or more embodiments, the carbon film is an activated carbon film that is microporous and includes a binder. Non-limiting examples of the binder of the activated carbon film include polyvinylidene fluoride (PVDF), polytetrafluoroethylene (PTFE), sodium alginate, sodium-carboxymethyl cellulose, an ion exchange polymer, or a combination thereof.

In one or more embodiments, the activated carbon film has a void fraction of about 30% to about 65%. In other embodiments, the activated carbon film electrode has a void fraction of about 30% to about 60%. Still yet, in other embodiments, the activated carbon film has a void fraction of about or in any range between about 30%, 35%, 40%, 45%, 50%, 55%, 60%, and 65%.

In some embodiments, the activated carbon film has a surface area of about 1200 to about 1400 square meters per gram. Still yet, in other embodiments, the activated carbon film has a surface area of about or in any range between about 1200, 1220, 1240, 1260, 1280, 1300, 1320, 1320, 1340, 1360, 1380, and 1400 square meters per gram.

A non-limiting example of an activated carbon film for the carbon-based cathode 112 is a low void fraction (about 30% to about 65%) and high surface area (about 1200 to about 1400 square meters per gram) material. In embodiments, the carbon-based cathode 112 is a planar structure with a thickness of about 0.1 to about 50 millimeters. In some embodiments, the carbon-based cathode 112 has a thickness of about 2 to about 5 millimeters. In other embodiments, the carbon-based cathode 112 has a thickness about or in any range between about 0.1, 0.2, 0.3, 0.4, 0.5, 0.6, 0.7, 0.8, 0.9, 1.0, 1.1, 1.2, 1.3, 1.4, 1.5, 1.6, 1.7, 1.8, 1.9, 2.0, 2.1, 2.2, 2.3, 2.4, 2.5, 2.6, 2.7, 2.8, 2.9, 3.0, 3.1, 3.2, 3.3, 3.4, 3.5, 3.6, 4.7, 4.8, 3.9, 4.0, 4.1, 4.2, 4.3, 4.4, 4.5, 4.6, 4.7, 4.8, 4.9, 5.0, 5.2, 5.4, 5.6, 5.8, 6.0, 6.2, 6.4, 6.6, 6.8, 7.0, 7.2, 7.4, 7.6, 7.8, 8.0, 8.2, 8.4, 8.6, 8.8, 9.0, 9.2, 9.4, 9.6, 9.8, 10.0, 10.5, 11.0, 11.5, 12.0, 12.5, 13.0, 13.5, 14.0, 14.5, 15.0, 15.5, 16.0, 16.5, 17.0, 17.5, 18.0, 18.5, 19.0, 19.5, 20.0, 20.5, 21.0, 21.5, 22.0, 22.5, 23.0, 23.5, 24.0, 24.5, 25.0, 25.5, 26.0, 26.5, 27.0, 27.5, 28.0, 28.5, 29.0, 29.5, 30.0, 30.5, 31.0, 31.5, 32.0, 32.5, 33.0, 33.5, 34.0, 34.5, 35.0, 35.5, 36.0, 36.5, 37.0, 37.5, 38.0, 38.5, 39.0, 39.5, 40.0, 40.5, 41.0, 41.5, 42.0, 42.5, 43.0, 43.5, 44.0, 44.5, 45.0, 45.5, 46.0, 46.5, 47.0, 47.5, 48.0, 48.5, 49.0, 49.5, and 50.0 millimeters.

In some embodiments, each carbon-based cathode 112 is a continuous planar structure without large apertures therethrough, for example. In other embodiments, each carbon-based cathode 112 is a planar structure with an annular hole therethrough, as shown in FIGS. 2A-2D for example. In embodiments, the carbon-based cathode 112 has a thin planar cylindrical shape, with or without an annular hole therethrough. However, the shape of the carbon-based cathode 112 is not limited to these shapes and can be any shape with the above-described thickness.

In one or more embodiments, the carbon-based cathode 112 is a single homogenous layer of a carbon-material, such as a woven carbon cloth, a carbon felt, or a carbon film.

The metal-based anode 108 includes a metal substrate in some embodiments. In other embodiments, the metal-based anode is a metal substrate with a metal oxide coating. The metal substrate is any coatable metal or metal alloy. The metal substrate can include plates, rods, tubes, wires or knitted wires, and/or expanded meshes of metals or metal alloys. Non-limiting examples of metals for the metal substrate include titanium, tantalum, aluminum, zirconium, niobium, or any combination or alloy thereof. Non-limiting examples of metal alloys for the metal substrate include titanium nickel alloys, titanium cobalt alloys, titanium iron alloys, titanium copper alloys, or any combination thereof. According to some embodiments, the metal substrate is a titanium mesh. In one or more embodiments, the metal-based anode includes about 5 grams per square meter (g/m²) of precious metal, but not limited to this amount. For example, the metal-based anode includes less than 2 g/m², or greater than 8 g/m² of precious metal. In some embodiments, the metal-based anode includes about 1 g/m² to about 10 g/m² precious metal, about 2 g/m² to about 8 g/m² precious metal, about 3 g/m² to about 7 g/m² precious metal, or about 4 g/m² to about 6 g/m² precious metal. Non-limiting examples of the precious metal include platinum, gold, or any combination or alloy thereof.

Before applying the metal oxide coating, the metal substrate is optionally cleaned to obtain a clean metal surface. The metal substrate is cleaned by, for example, mechanical cleaning, degreasing, chemical or electrolytic cleaning, or any combination thereof. Optionally, the metal base is etched to obtain a surface roughness or surface morphology. For example, acids, e.g., hydrochloric, sulfuric, perchloric, nitric, oxalic, tartaric, phosphoric acids, or combinations thereof, or caustic compounds, e.g., potassium hydroxide/hydrogen peroxide, are used to chemically etch the surface of the metal base. Plasma spraying is another example of a process used for providing a roughened metal surface.

Once prepared, the metal substrate is coated with one or more metal oxides. Non-limiting examples of metal oxides include platinum oxide, palladium oxide, rhodium oxide, iridium oxide, ruthenium oxide, titanium oxide, mixtures thereof, or mixtures with other metals. Other non-limiting examples of metal oxides include manganese dioxide, lead dioxide, cobalt oxide, ferric oxide, platinate coatings such as Mₓ Pt₃O₄ where M is an alkali metal, and x is typically targeted at approximately 0.5, nickel-nickel oxide, nickel plus lanthanide oxides, or any combination thereof.

The metal oxide precursors for the coating are combined in a coating composition and applied to the metal substrate by any process that applies a liquid coating composition to a metal substrate. Such methods include dip spin and dip drain techniques, brush applications, roller coating and spray applications, such as electrostatic spraying. Once a uniform coating is applied to the metal substrate, heat is applied to the coated metal substrate to effect thermal decomposition of the precursors and form the metal oxide coating. Heating is performed, for example, at a temperature of about 425 to about 535 degrees Celsius for about 3 to about 20 minute and is performed in an oxidative environment, such as in air or in oxygen.

In one or more embodiments, the metal oxide coating on the metal substrate includes ruthenium oxide, iridium oxide, titanium oxide, or a combination thereof. Ruthenium chloride (RuCl₃), iridium chloride (IrCl₃ or H₂IrCl₃), and titanium isopropoxide (Ti{OCH(CH₃)₂}₄), commonly referred to as titanium tetraisopropoxide or TTIP, are combined as precursors in a coating composition, which are deposited on the surface of the metal substrate to form the metal-based anode 108.

In one or more embodiments, the metal-based anode 108 is a planar structure with a thickness of about 0.1 to about 3 millimeters. In some embodiments, the metal-based anode 108 has a thickness of about 0.1 to about 1.2 millimeters. In other embodiments, the carbon-based cathode has a thickness about or in any range between about 0.1, 0.2, 0.3, 0.4, 0.5, 0.6, 0.7, 0.8, 0.9, 1.0, 1.1, 1.2, 1.3, 1.4, 1.5, 1.6, 1.7, 1.8, 1.9, 2.0, 2.1, 2.2, 2.3, 2.4, 2.5, 2.6, 2.7, 2.8, 2.9, and 3.0 millimeters.

In other embodiments, each metal-based anode 108 is a planar structure with an annular hole therethrough, as shown in FIGS. 2A-2D for example. In embodiments, the metal-based anode 108 has a thin planar cylindrical shape, with or without an annular hole therethrough. However, the shape of the metal-based anode 108 is not limited to these shapes and can be any shape with the above-described thickness.

In some embodiments, the electrode stack further includes a membrane on the carbon-based anode and/or on the metal-based cathode. The membrane 119 and 120 (FIGS. 2B-2D) is an ion exchange membrane in embodiments. An anion exchange membrane 119 is used when the membrane is on the metal-based anode, and a cation exchange membrane 120 is used when the membrane is on the carbon-based cathode. A cation exchange membrane is a membrane that is selectively permeable to cations. An anion exchange membrane is a membrane that is selectively permeable to anions. The membrane is in a form of a film, a layer, a sheet, a coating, or a combination thereof, and the membrane is arranged on a surface of an electrode (thus, the metal-based anode and/or the carbon-based cathode) or is free-standing. The membrane is on, directly on, or in contact with the electrode in some embodiments. In other embodiments, the membrane surrounds the electrode.

To make the electrode stacks of the electrochemical device 100, the above-described layers of the cell, including the carbon-based cathode 112, metal-based anode 108, current collectors 106, and separators 110 are stacked upon one other in any order provided that the carbon-based cathode 112 is separated from the metal-based anode 108 by the separator. As a result, the metal-based anode 108 contacts the separator 106, and the separator 106 also contacts the carbon-based cathode 112. Current collectors 106 are layered to separately contact each of the metal-based anode 108 and the carbon-based cathode 112.

Another layer of each of the metal-based anode 108 and carbon-based cathode 112 can be layered on the current collector 106, such that the current collectors 106 are sandwiched between contacting layers of each of the metal-based anode 108 carbon-based cathode 112. In one or more embodiments, a current collector 106 is sandwiched between layers of the carbon-based cathode 112, and a current collector 106 is not attached to or in contact with the metal-based anode 108.

In one or more embodiments, the membrane 120 (FIGS. 2C and 2D) (e.g., cation exchange membrane) is on a first surface of the carbon-based cathode 112 opposite a second surface of the carbon-based cathode 112 which is in contact with the current collector 106. Thus, the membrane 120 contacts the carbon-based cathode 112 and the separator 106. In other embodiments, the membrane 119 (FIGS. 2B and 2D) (e.g., anion exchange membrane) may be on a first surface of the metal-based anode 108 opposite a second surface of the metal-based anode 108 which is in contact with the current collector 106. Thus, the membrane contacts the metal-based anode 112 and the separator 106.

An optional feed channel or spacer 121 may be present in the electrochemical device as shown in FIG. 2D. The feed channel or spacer 121 can create a larger flow channel for the through stream. Non-limiting examples of a form of the feed channel or spacer 121 are a netting or mesh. Non-limiting examples of materials for the feed channel or spacer 121 include polypropylene, polyethylene, nylon, or a combination thereof.

The carbon-based cathode 112 and metal-based anode 108 are spaced apart from one another and arranged in the electrode stacks 118 of the electrochemical devices in various configurations. In addition to the stacked electrode flow-by and flow-through device configurations as shown in FIGS. 2A-2D, the electrochemical devices have other configurations. In other embodiments, the carbon-based electrode is part of an electrode stack in a rolled or z-folded configuration.

The regenerated electrochemical devices described herein are used to purify aqueous solutions by at least partially removing or reducing the target ionic species from the aqueous solution. The input stream of aqueous solution is an industrial wastewater stream or a residential water stream, for example. The starting concentration of target species in the input stream varies depending on the particular species. In one or more embodiments, the starting concentration (parts per million/ppm) of the target species is 1 to about 10,000 parts per million. In other embodiments, the starting concentration of the target species is about 1 to about 1,000 parts per million.

The regeneration method and system described herein regenerates the carbon-based electrode with an efficiency of greater than 100% in some embodiments, and about 100% to about 250% in other embodiments. Regeneration efficiency is calculated as follows: regeneration efficiency=100*(mass copper recovered by regeneration/mass copper captured), where mass copper captured=mass copper in original aqueous solution feed−mass copper in effluent. The same regeneration solution was used for more than one cycle of treatment and becomes more and more concentrated over time.

To collect reduced metal on the carbon-based electrode, the electrochemical device with the electrode cell stack is connected to a power supply via the electrical connectors and wiring, and a controller applies a potential (E+ or E−) to the electrodes. The asymmetry of the electrodes provides a voltage distribution across the electrodes, which equates to a different voltage at each electrode that controls the speciation of the target ionic species at electrodes. A negative voltage is applied to the carbon-based cathode, and a positive voltage is applied to the metal-based anode. As a result, the removal of the target ionic species can be forced to occur predominately by plating on the carbon-based cathode, as explained in detail below. The applied voltage is split between the carbon-based cathode and the metal-based anode according to the electrodes' material properties, such as mass, area, surface area, resistance, etc. For example, if 1.6 V is applied to the device, the carbon-based cathode may have an applied voltage of −0.9 V versus standard hydrogen electrode (SHE) and the metal-based anode may have an applied voltage of +0.7 V versus SHE.

Upon application of a voltage/potential to the electrochemical device, the target species are removed or reduced from the aqueous solution by various processes, including physical adsorption to an electrode; electrical attraction (capacitive adsorption) to an electrode; electron transfer reactions that directly or indirectly create new target species (Faradaic reactions) that become immobilized on an electrode. Electroplating (also referred to as electrodeposition or plating) used in the herein described electrochemical devices removes the target species from the aqueous solution by reduction to form a solid lead metal (i.e., Pb′ in solution is electroplated as Pb(s)) on the carbon-based cathode 112. The applied voltage is selected to effect electroplating of target species on the carbon-based cathode 112.

The Pourbaix diagram of the target species is used to select the voltage and pH conditions to electroplate the target on the carbon-based cathode 112. A Pourbaix diagram is specific for a particular species and shows potential/voltage (y-axis) as a function of pH (x-axis). The Pourbaix diagram illustrates possible stable (equilibrium) phases of the target species in an aqueous electrochemical system. The desired applied potential (E) is selected and applied to electroplate (or electrodeposit) the target species on the carbon-based cathode 112 (the electrode which a negative potential will be applied). The Pourbaix diagram for each target species in the aqueous solution is used to determine the operating conditions (i.e., electrode voltage and pH) under which the target species will be removed or partially removed (by Faradaic reactions) from the aqueous solution by electroplating as a reduced solid. Pourbaix diagrams for various target species are available from various sources, including for example, Pourbaix, Marcel, Atlas of Electrochemical Equilibria in Aqueous Solutions, Houston, Tex., National Association of Corrosion Engineers, 1974, incorporated herein in its entirety by reference.

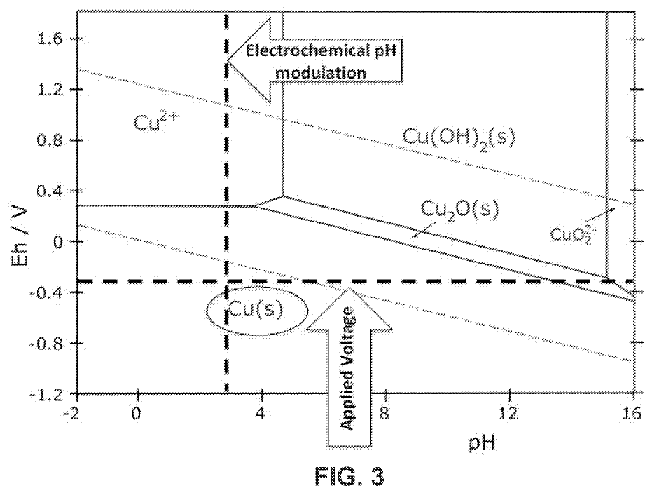

An example of a Pourbaix diagram for copper is shown in FIG. 3. Predominant ion boundaries are represented by lines, and as such, the Pourbaix diagram is read much like a standard phase diagram with a different set of axes, with potential (V) on the y-axis, and pH on the x-axis. The bulk aqueous solution includes copper ions as Cu²⁺, which are immobilized as Cu(OH)₂(s) and Cu₂O(s) when oxidized under alkaline conditions, and electroplated as Cu(s) on the cathode under the shown operating conditions. In particular, when applying a voltage of −0.3 V to the carbon-based cathode as illustrated by the horizontal line, the pH (illustrated by the vertical line) is modulated such that the intersection with the potential (horizontal line) represents the species of the metal that will exist under those conditions. With an applied voltage of about −0.3 V to about −0.4 V versus a normal hydrogen electrode (NHE), copper (Cu(s)) is plated on the cathode when the pH 0 to 14.

Other target species can be removed under similar mechanisms but under different voltage regions. In embodiments, a cell potential of about 0.6 to about 2.5 Volts is applied to the electrochemical device, which will be split between the cathode and anode. In other embodiments, a cell potential about or in any range between about 0.6, 0.7, 0.8, 0.9, 1.0, 1.1, 1.2, 1.3, 1.4, 1.5, 1.6, 1.7, 1.8, 1.9, 2.0, 2.1, 2.2, 2.3, 2.4, and 2.5 Volts.

A negative potential (E−) is applied to the cathode, and a positive potential (E+) is applied to the anode. The potential (V) and pH at each of the anode and cathode are measured, and the operating conditions (i.e., the applied potential) is adjusted to obtain a near electrode potential (i.e., anode potential) and pH that corresponds to conditions under which the target species will be electroplated and removed from the aqueous solution. The electrochemical cell is maintained under favorable conditions to effect electroplating of the target ionic species from the aqueous solution at the carbon-based cathode. Table 1 below shows operating conditions, including total applied cell voltage ranges used in one or more embodiments.

TABLE 1
Operating conditions for electroplating target species

| Target species | Cell voltage range (V) |
|---|---|
| Pb | Greater than 1.5 |
| Cu | Greater than 1.2 |

### EXAMPLES

### Example 1

The electrochemical device included a metal-based anode and a carbon-based cathode. The anode was a mixed metal oxide anode formulated from a combination of ruthenium oxide and iridium oxide coated on a platinum mesh. The cathode was a carbon felt. The electrochemical device was used to separate and plate metals from an aqueous input stream that includes copper (Cu), which was plated on the carbon felt cathode. The electrochemical device was operated at 1.9 V±0.1 V and 0.2 gallons per minute (gpm) to reduce an input stream of acidic copper wastewater stream with a pH of about 1.6 and concentration of about 300 parts per million (ppm) copper to an average of about 1.5 ppm copper in the output stream. Fifty (50) gallons were treated.

In order to regenerate the device, and in particular to remove reduced plated copper (Cu(s)) from the carbon felt cathode, the device was run with a regeneration solution. The regeneration solution included a combination of tap water and one, two, or all of the following: concentrated sulfuric acid (added until the solution was a desired pH), 0.3-0.6% hydrogen peroxide, and 0.05 molar (M) nitric acid (Table 2). The regeneration solution, with a volume of 150 Liter, was stored in a tank and recirculated in batch mode through the electrochemical device to recover copper from the carbon cartridges. The regeneration solution was backflushed through the electrodes. No voltage was applied during regeneration. Regeneration was performed for 1 hour, which resulted in recovering more than 90% of the copper initially removed from the wastewater stream by the electrochemical device, providing a final concentration of about 1000 ppm recovered copper for regeneration solution 3, including all of nitric acid, hydrogen peroxide, and sulfuric acid at pH 1.2.

TABLE 2
Acid only regeneration solutions

| Regeneration | Sulfuric Acid | Hydrogen Peroxide | Nitric Acid |
|---|---|---|---|
| Solution | (pH adjustment) | (%) | (N) |
| 1 | 1.2 | — | — |
| 2 | 1.2 | 0.3 | — |
| 3 | 1.2 | 0.3 | 0.05 |
| 4 | 0.6 | 0.6 | — |
| 5 | 0.4 | 1 | — |

Adding hydrogen peroxide to the regeneration solution provided an incremental improvement in copper recovery (Table 3, compare solutions 1 to 2), shown by a slight increase in regeneration efficiency when solutions 1 and 2 are compared. However, with the addition of nitric acid, there was a noticeable improvement (Table 3, compare solutions 2 and 3), reaching over 200% efficiency.

To further examine the effect of pH and the presence of hydrogen peroxide, regeneration solutions 4 and 5 were tested, which included increased amounts of hydrogen peroxide and without nitric acid. Without nitric acid, there was no improvement in regeneration efficiency.

TABLE 3
Copper recovery and regeneration efficiency

| | | | | | | Regeneration |
|---|---|---|---|---|---|---|
| Regeneration | Feed | Treated* | Captured | Recovered | Recovered | Efficiency |
| Solution | (ppm) | (ppm) | (mg) | (ppm) | (mg) | (%) |
| 1 | 87 | 1.4 | 102720 | 297 | 44550 | 43 |
| 2 | 300 | — | 56435 | 220 | 33000 | 58 |
| 3 | 300 | — | 56435 | 780 | 117000 | 207 |
| 4 | 300 | — | 56435 | 250 | 37750 | 67 |
| 5 | 300 | — | 56435 | 500 | 75500 | 67 |

*Treated effluent was estimated to be 1.4 ppm in all cases

### Example 2

The system was set-up in the same manner as Example 1 and run in batch-mode for several hours to remove copper from the feed stream. The system was operated at 1.5 Volts and 1 gallon per minute to reduce an input acidic copper stream. The input stream was a synthetic tap water adjusted to about pH 1.3 and spiked with about 400 ppm copper. The copper content was reduced to less than 0.3 parts per million in the output stream. A total of 30 gallons were treated.

The regeneration solution was tap water spiked with concentrated sulfuric acid to a pH of about 1.1. The regeneration step was run for three hours. Nearly 100% of the copper initially removed from the wastewater stream was recovered from the electrodes in the first hour of regeneration (Table 4). The same device was operated for all trials, therefore the amount of copper captured and recovered are cumulative over time. The regeneration efficiency is shown for trials 1-4 and 5-15 as representative results.

TABLE 4
Copper recovery and regeneration from synthetic wastewater

| | | | Total | Total | Total | Regeneration |
|---|---|---|---|---|---|---|
| | Feed | Treated | Captured | Recovered | Recovered | Efficiency |
| Trial | (ppm) | (ppm) | (mg) | (ppm) | (mg) | (%) |
| 1 | 314 | <0.1 | 29712 | 394 | 77547 | — |
| 2 | 314 | <0.1 | 59425 | 400 | 78728 | — |
| 3 | 296 | <0.1 | 87434 | 523 | 102937 | — |
| 4 | 416 | <0.1 | 126798 | 709 | 139545 | 49 |
| 5 | 454 | <0.1 | 42960 | 756 | 148796 | — |
| 6 | 475 | <0.1 | 87907 | 814 | 160211 | — |
| 7 | 487 | 0.219 | 133968 | 898 | 176744 | — |
| 8 | 251 | <0.1 | 157719 | 952 | 187373 | — |
| 9 | 306 | 0.318 | 186644 | 1022 | 201150 | — |
| 10 | 268 | 81 | 204339 | — | — | — |
| 11 | 554 | 49.7 | 252059 | — | — | — |
| 12 | 55.3 | 0.138 | 257278 | — | — | — |
| 13 | 306 | 0.29 | 286206 | 1398 | 275154 | — |
| 14 | 168 | 0.123 | 302091 | 1426 | 280665 | — |
| 15 | 315 | 0.102 | 331889 | 1570 | 309007 | — |
| 16 | 415 | 0.083 | 371150 | 1670 | 328689 | 51 |

### Example 3

Preliminary studies were conducted to assess the effectiveness of several regeneration solutions. The addition of a chelating agent, type of oxidizing agent, and pH were tested. Either 5 mL of hydrogen peroxide (H₂O₂) or 2 g sodium persulfate (persulfate) was added to 250 mL of deionized water. The pH was adjusted to pH˜2 with sulfuric acid or to pH˜10 with sodium hydroxide. Two (2) g of L-alanine was added to regeneration solutions 5-8. One (1) g of high purity copper metal (solid) was placed in 8 different regeneration solutions, and dissolution was measured at 2- and 5-minute time steps, as shown in Table 5. Copper concentration was measured using a HACH DR 1900 handheld sensor.

The higher the concentration of copper in solution, the more effective the regeneration solution. Additionally, efficient regeneration solutions should be rapidly effective, therefore data collected within a few minutes were most relevant.

Regeneration solution 5 was the most effective, while 2 was the least, showing that the addition of a chelator to H₂O₂ greatly increased performance under acidic and basic conditions. This series of experiments served as a predictor of how each solution would perform in the described systems at removing copper from a carbon electrode.

TABLE 5
Regeneration solutions with chelator and/or oxidizing agent

| Regeneration | | Chelating | Oxidizing |
|---|---|---|---|
| Solution | pH | Agent | Agent |
| 1 | 2.14 | — | H₂O₂ |
| 2 | 9.9 | — | H₂O₂ |
| 3 | 2.14 | — | Persulfate |
| 4 | 9.9 | — | Persulfate |
| 5 | 2.14 | L-alanine | H₂O₂ |
| 6 | 9.9 | L-alanine | H₂O₂ |
| 7 | 2.14 | L-alanine | Persulfate |
| 8 | 9.9 | L-alanine | Persulfate |

TABLE 6
Copper dissolution for regeneration solutions in Table 5

| | |
|---|---|
| Regeneration | Cu concentration (ppm) |

| Solution | pH | 2 min | 5 min | 10 min | 20 min |
|---|---|---|---|---|---|
| 1 | 2.14 | 2.49 | 5.47 | 10.05 | 23.93 |
| 2 | 9.9 | <0.1 | <0.1 | <0.1 | 0.54 |
| 3 | 2.14 | 2.62 | >8 | 20.18 | 42.23 |
| 4 | 9.9 | 0.93 | 4.86 | 12.58 | 43.22 |
| 5 | 2.14 | 7.57 | >8 | 41.12 | 69.51 |
| 6 | 9.9 | 2.50 | >8 | 16.84 | 42.25 |
| 7 | 2.14 | 1.30 | 2.19 | 4.276 | 7.258 |
| 8 | 9.9 | 2.31 | 4.48 | 10.25 | 25.11 |

Various embodiments of the present invention are described herein with reference to the related drawings. Alternative embodiments can be devised without departing from the scope of this invention. Although various connections and positional relationships (e.g., over, below, adjacent, etc.) are set forth between elements in the following description and in the drawings, persons skilled in the art will recognize that many of the positional relationships described herein are orientation-independent when the described functionality is maintained even though the orientation is changed. These connections and/or positional relationships, unless specified otherwise, can be direct or indirect, and the present invention is not intended to be limiting in this respect. Accordingly, a coupling of entities can refer to either a direct or an indirect coupling, and a positional relationship between entities can be a direct or indirect positional relationship. As an example of an indirect positional relationship, references in the present description to forming layer “A” over layer “B” include situations in which one or more intermediate layers (e.g., layer “C”) is between layer “A” and layer “B” as long as the relevant characteristics and functionalities of layer “A” and layer “B” are not substantially changed by the intermediate layer(s).

The following definitions and abbreviations are to be used for the interpretation of the claims and the specification. As used herein, the terms “comprises,” “comprising,” “includes,” “including,” “has,” “having,” “contains” or “containing,” or any other variation thereof, are intended to cover a non-exclusive inclusion. For example, a composition, a mixture, process, method, article, or apparatus that comprises a list of elements is not necessarily limited to only those elements but can include other elements not expressly listed or inherent to such composition, mixture, process, method, article, or apparatus.

Additionally, the term “exemplary” is used herein to mean “serving as an example, instance or illustration.” Any embodiment or design described herein as “exemplary” is not necessarily to be construed as preferred or advantageous over other embodiments or designs. The terms “at least one” and “one or more” are understood to include any integer number greater than or equal to one, i.e. one, two, three, four, etc. The terms “a plurality” are understood to include any integer number greater than or equal to two, i.e. two, three, four, five, etc. The term “connection” can include an indirect “connection” and a direct “connection.”

References in the specification to “one embodiment,” “an embodiment,” “an example embodiment,” etc., indicate that the embodiment described can include a particular feature, structure, or characteristic, but every embodiment may or may not include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

For purposes of the description hereinafter, the terms “upper,” “lower,” “right,” “left,” “vertical,” “horizontal,” “top,” “bottom,” and derivatives thereof shall relate to the described structures and methods, as oriented in the drawing figures. The terms “overlying,” “atop,” “on top,” “on,” “positioned on” or “positioned atop” mean that a first element, such as a first structure, is present on a second element, such as a second structure, wherein intervening elements such as an interface structure can be present between the first element and the second element. The term “direct contact” means that a first element, such as a first structure, and a second element, such as a second structure, are connected without any intermediary conducting, insulating or semiconductor layers at the interface of the two elements.

The terms “about,” “substantially,” “approximately,” and variations thereof, are intended to include the degree of error associated with measurement of the particular quantity based upon the equipment available at the time of filing the application. For example, “about” can include a range of ±8% or 5%, or 2% of a given value.

The flowchart and block diagrams in the Figures illustrate possible implementations of fabrication and/or operation methods according to various embodiments of the present invention. Various functions/operations of the method are represented in the flow diagram by blocks. In some alternative implementations, the functions noted in the blocks can occur out of the order noted in the Figures. For example, two blocks shown in succession can, in fact, be executed substantially concurrently, or the blocks can sometimes be executed in the reverse order, depending upon the functionality involved.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiments were chosen and described in order to best explain the principles of the invention and the practical application, and to enable others of ordinary skill in the art to understand the invention for various embodiments with various modifications as are suited to the particular use contemplated.

While the preferred embodiments to the invention have been described, it will be understood that those skilled in the art, both now and in the future, may make various improvements and enhancements which fall within the scope of the claims which follow. These claims should be construed to maintain the proper protection for the invention first described.

What is claimed is:

1. A method for removing a metal from a carbonaceous electrode, the method comprising:
providing a regeneration solution that includes an acid, an oxidizing agent, or a combination thereof;
applying the regeneration solution to the carbonaceous electrode;
oxidizing the metal on the surface of the carbonaceous electrode; and
collecting the oxidized metal in the regeneration solution.

2. The method of claim 1, wherein the regeneration solution comprises the acid and the oxidizing agent.

3. The method of claim 1, wherein the oxidizing agent is a peroxide, a persulfate, or a combination thereof.

4. The method of claim 1, wherein the oxidizing agent is hydrogen peroxide, sodium persulfate, potassium persulfate, sodium hypochlorite chlorine, or any combination thereof.

5. The method of claim 1, wherein the acid comprises one or more strong acids.

6. The method of claim 1, wherein the acid is sulfuric acid (H₂SO₄), hydrochloric acid (HCl), nitric acid (HNO₃), hydrobromic acid (HBr), hydroiodic acid (HI), perchloric acid (HClO₄), chloric acid (HClO₃), or any combination thereof.

7. The method of claim 1, wherein the regeneration solution further comprises a chelating agent.

8. The method of claim 1, wherein the carbonaceous electrode is a carbon felt, a woven carbon cloth, a carbon film, or a non-woven.

9. The method of claim 1, wherein the carbonaceous electrode is part of an electrode stack configured in layers, configured in a rolled electrode stack, or configured in a z-fold.

10. The method of claim 9, wherein a membrane is on the carbonaceous electrode.

11. The method of claim 9, wherein the membrane is an ion exchange membrane, wherein the ion exchange membrane is an anion exchange membrane or a cation exchange membrane.

12. The method of claim 9, wherein the membrane is a bipolar membrane.

13. The method of claim 7, wherein the membrane is in a form of a film, a layer, a sheet, a coating, or a combination thereof.

14. The method of claim 6, wherein the electrode stack further comprises a metal-containing electrode.

15. The method of claim 14, wherein a membrane is on the metal-containing electrode.

16. The method of claim 15, wherein the membrane is an ion exchange membrane, wherein the ion exchange membrane is an anion exchange membrane or a cation exchange membrane.

17. The method of claim 15, wherein the membrane is in a form of a film, a layer, a sheet, a coating, or a combination thereof.

18. The method of claim 9, wherein the electrode stack further comprises a current collector in contact with the carbonaceous electrode.

19. The method of claim 18, wherein the current collector comprises graphite, titanium, stainless steel, aluminum, copper, nickel, or a combination thereof.

20. The method of claim 18, wherein the current collector is in a form of a film, a layer, a metal sheet, a foil sheet, a mesh sheet, or a combination thereof.

21. The method of claim 14, wherein the electrode stack further comprises a current collector in contact with the metal-containing electrode.

22. The method of claim 21, wherein the current collector comprises graphite, titanium, stainless steel, aluminum, copper, nickel, or a combination thereof.

23. The method of claim 21, wherein the current collector is in a form of a film, a layer, a metal sheet, a foil sheet, a mesh sheet, or a combination thereof.

24. The method of claim 14, wherein the electrode stack further comprises a separator arranged between the carbonaceous electrode and the metal-containing electrode.

25. The method of claim 24, wherein the separator comprises a dielectric material.

26. The method of claim 24, wherein the dielectric material comprises a polymeric material, cellulosic material, a silica containing material, or a combination thereof.

27. A regeneration solution for a carbonaceous electrode, the regeneration solution comprising:
an acid; and
a peroxide in an amount of about 0.1 to about 5 volume percent, or about 0.1 to about 5 weight percent;
wherein the regeneration solution has a pH of about 0.5 to about 10.

28. The regeneration solution of claim 27, wherein the acid is one or more strong acids.

29. The regeneration solution of claim 28, wherein the acid is sulfuric acid (H₂SO₄), hydrochloric acid (HCl), nitric acid (HNO₃), hydrobromic acid (HBr), hydroiodic acid (HI), perchloric acid (HClO₄), chloric acid (HClO₃), or any combination thereof.

30. The regeneration solution of claim 27, wherein the acid is sulfuric acid.
